(19) United States
(12) Patent Application Publication
(10) Pub. No.: US 2003/0218875 A1
(43) Pub. Date: Nov. 27, 2003

(54) Lighting system and lamp with optimal position placement for television, news and motion picture studio

(76) Inventor: Mofid Bissada, Santa Monica, CA (US)

Correspondence Address: Robert J. Lauson, Esq., CISLO & THOMAS LLP, 233 Wilshire Boulevard, Suite 900, Santa Monica, CA, 90401-1211, US

(21) Appl. No.: 10/152,465

(22) Filed: May 21, 2002

(51) Int. Cl. F21V 9/16

(52) U.S. Cl. 362/84; 362/216; 362/225

(57) ABSTRACT

A lighting system for projecting a soft light has a light source with flat reflector to provide a fill light without any spill light. The light source is located at a position other than a parallel position, the socket assembly is mounted on a V position at a 110° Degree angle and to be mounted on both sides of the lighting fixture assembly. This placement provides a greater light output than is achievable by position the light source in a parallel, in addition to doubling the amount of the tubes used in the same space thus decreasing the size and the weight of the housing and increasing the light output. Furthermore the Fluorescent tubes will act as a reflector due to the angle position.

### BACKGROUND OF THE INVENTION

1. Field of the Invention

This invention relates generally to lighting assemblies for projecting a fill light and more particularly to a system having a reflector and a Fluorescent source wherein the source of the light optimally placed with reference to both sides of the end plate of the housing, in addition the tubes will act as a reflector due to the angle mounting position.

2. Description of the Related Art

Fluorescent lighting in the Motion Picture, TV Studio, and location is a fairly new technology as only recently the Fluorescent tubes became a color corrected tube that permits the blend of the Fluorescent tube with incandescent halogen lamp which has been widely used in the art field of Cinematography. It has been a standard conventional practice to position all Fluorescent tubes in parallel to one another and a standard spacing between the socket end assembly. This common tube position has always been a common practice in positioning the tube within the housing. However, the placement of the tube in a parallel is discouraged as counterproductive in that its light would be absorbed by the housing and spill light will be encountered which has to be corrected by a Snoot to cut any unnecessary spill light. Further the position of the tubes being in parallel increases the dimensions and the weight of the fixture which will only permit a smaller quantities of tube to be spread in a large housing for a complete accommodation of the tube size.

The purpose of positioning the tube in a V 110° Degree angle on both sides of the housing end panel permits to double the amount of the Fluorescent tubes in a giving housing, thus increasing the light output and decreasing the dimensions of the housing as well as the weight, in this mounting position the tubes act as a reflector effect. Furthermore the complete elimination of the Snoot requirements that is needed to eliminate any spill light.

### SUMMARY OF THE INVENTION

The present invention provides such an improved illumination and light projection from a given lighting fixture design. Accordingly it is a primary object of the invention to provide a lighting system which projects an increased amount of light from a given light source and toward a target given power input than has previously been achievable. Furthermore another object of the invention to provide a housing that is compact, easy to handle and carry, lighter in weight, lesser in power consumption, higher in light output and simple to assemble and repair. The mounting position of the Fluorescent tube angle permits an increase in the amount of tubes utilized in a giving housing by position each tube on both sides of the end panel of the housing thus doubling the amount of tubes and reducing the size of the housing between 33,33% to 50% from the standard size. In addition in utilizing the Fluorescent tubes as a reflector.

### BRIEF DESCRIPTION FO THE DRAWINGS

FIG. 1, FIG. 1A, FIG. 1B, FIG. 1C is a side view showing the placement of the socket and its angle position on both sides of the of end plate. The drawing of the straight line socket is located on one side of the end panel, and the dotted one on the opposite side. The socket Angle position and positioning the socket on both sides of the end plates permits the mounting of twice the tubes within ⅔ of the space allocated.

FIG. 2 Shows an example of the invention by using a housing utilizing 2 tubes within a ⅓ less of the space.

FIG. 3 Shows a front view of the invention by using a housing utilizing 4 tubes within a condense space by mounting the tubes on both sides of the end panel, with an angle position of the socket which will permit to have a controlled light flow, furthermore a savings in space and an increase in the amount of tubes and light output

FIG. 4 Shows a front view of the invention by using a housing utilizing 8 tubes within a condense space by mounting the tubes on both sides of the end panel and with an angle position of the socket which will permit to have a controlled light flow furthermore a savings in space and an increase in the amount of tubes and light output

FIG. 5 Shows a front view of the invention by using a housing utilizing 12 tubes within a condense space by mounting the tubes on both sides of the end panel and with the angle position of the socket which will permit to have a controlled light flow furthermore a savings in space and an increase in the amount of tubes and light output.

### DESCRIPTION OF THE PREFERRED EMBODIMENTS

The invention will now be described with reference to preferred embodiments.

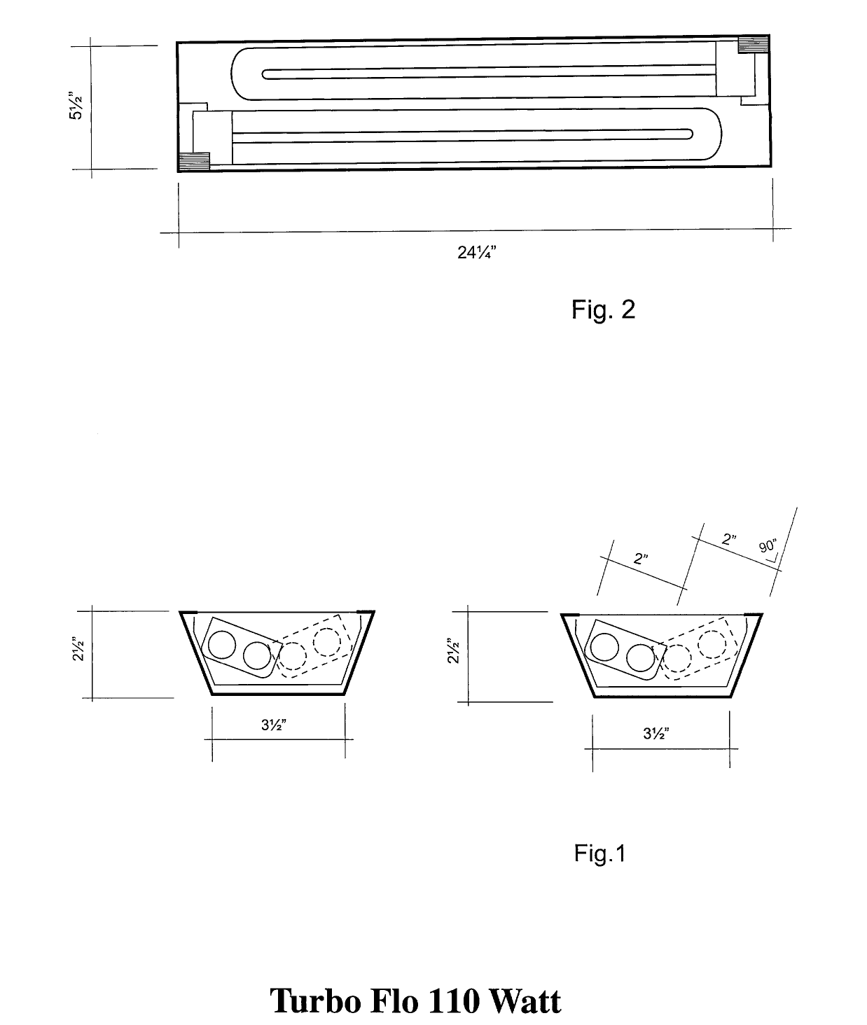

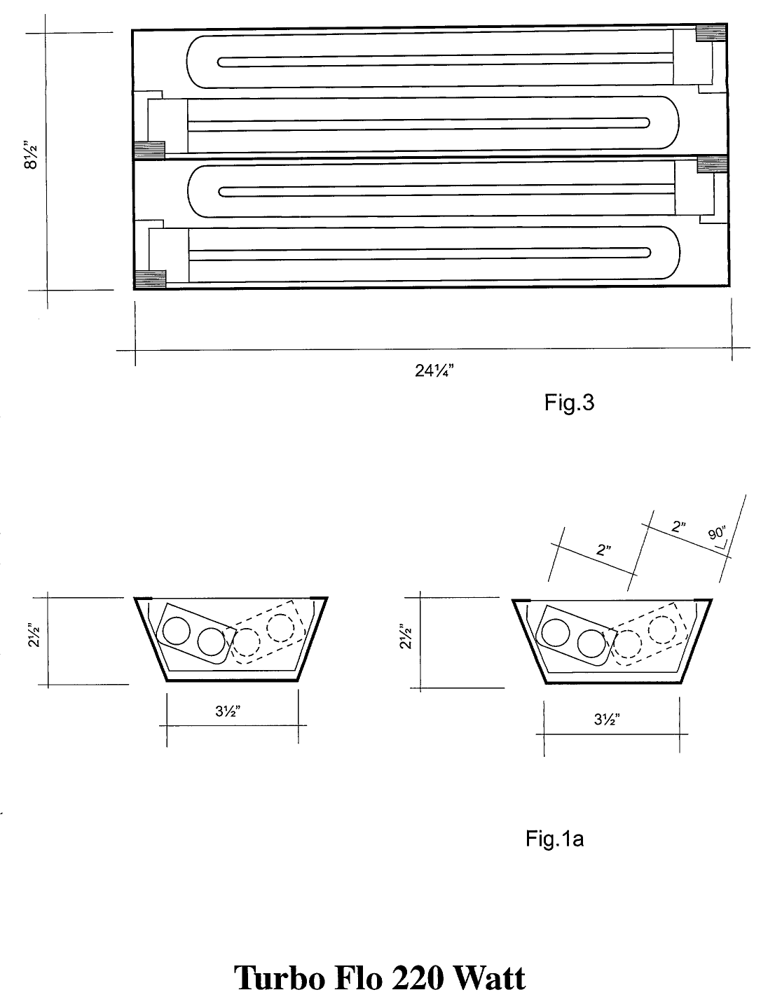

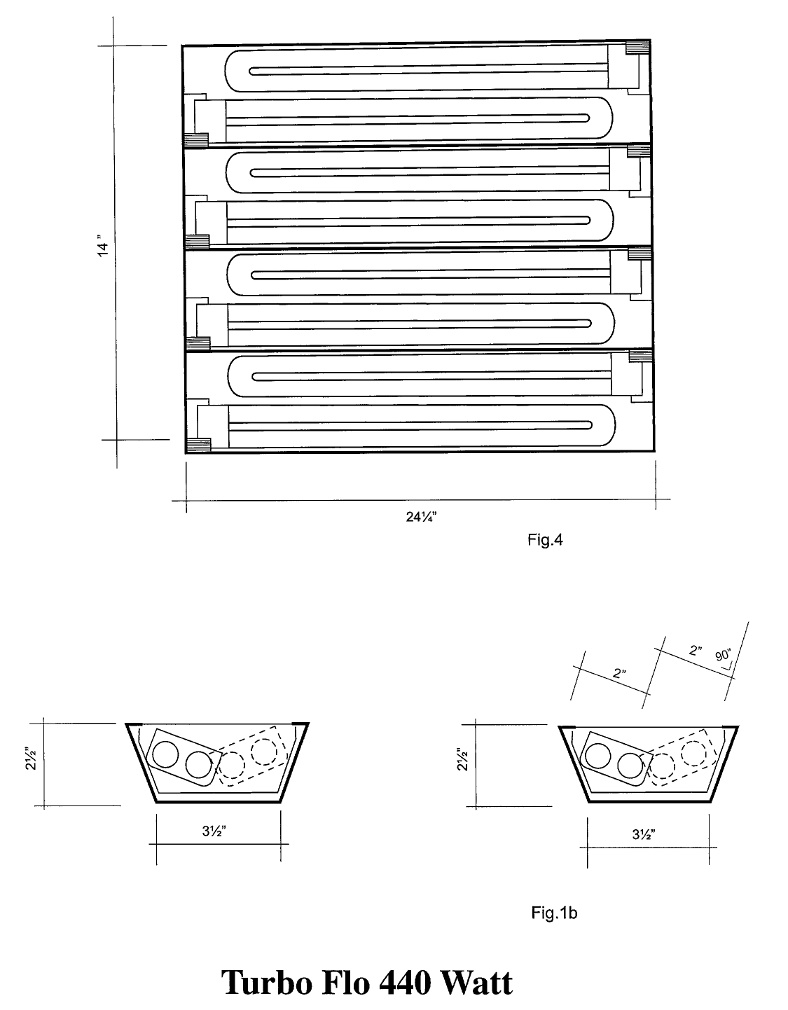

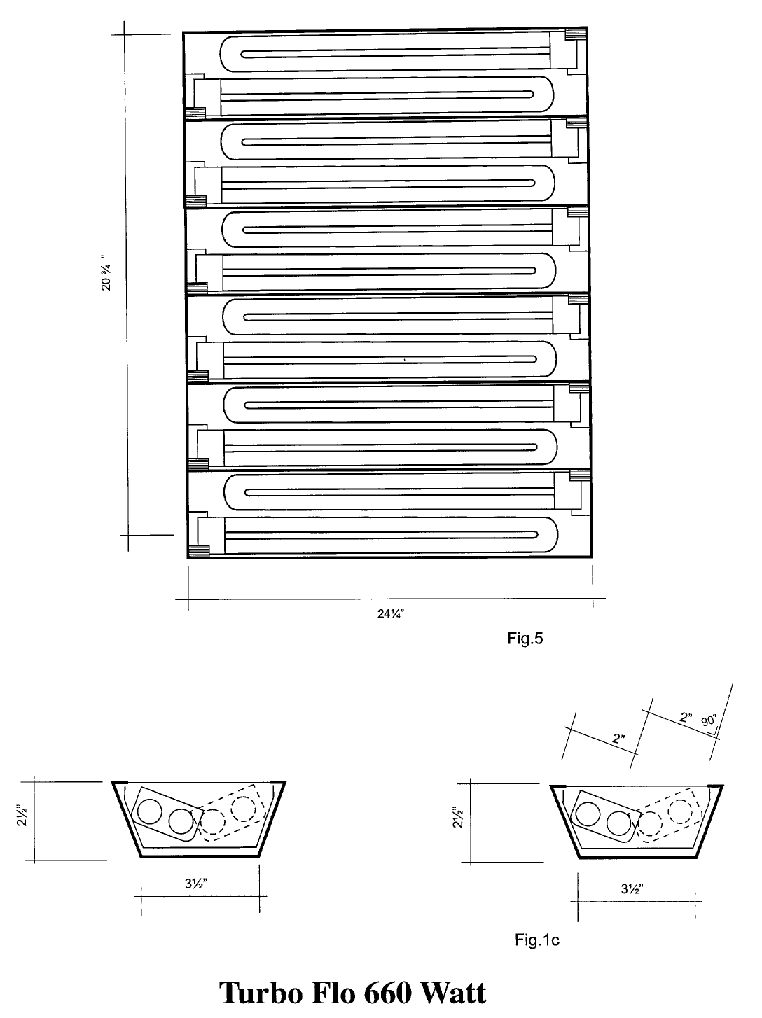

FIG. 1 FIG. 1A, FIG. 1B, FIG. 1C it shows the base socket mounting position which is contrary to the conventional socket mounting position, by mounting the socket in 110° Degree angle in opposite direction of the housing allows the doubling of the tubes in a lesser space and maximize the benefit of the reflector by increasing the light output within a lesser space. This invention permitted to maximize the benefit of the Fluorescent tubes beam candlepower and rely solely on the performance of the Fluorescent tubes and its mounting angle, rather then the size of the housing which would have resulted in a light loss in a larger housing, and lesser amount of Fluorescent Tubes within the range of 33,33% to 50%.

This invention permits the maximization of the Fluorescent tubes performance which will result in higher light output, no loss of light within a housing fixtures thus allowing the light output to be directed to the object rather then loosing most of the light output within the fixture housing. This design allows the output of the light to exit the fixture and provide fill light towards the object.

Conventional wisdom in the Fluorescent tube lighting fixture design teaches that the Fluorescent tubes are mounted in parallel position to provide the best output. This position follows from basic geometry principles. However, this premise has surprisingly been found to be not valid for the U Shape Fluorescent tube. Instead the light source can be positioned in a different angle and still will result in light output superior to the conventional way of mounting and the use of Fluorescent tube as a reflector.

The front view on FIG. 2, FIG. 3, FIG. 4, FIG. 5 illustrate the position of the Fluorescent tube mounting position which permitted the decrease of the housing fixtures and an increase in the light output by increasing the quantities of Fluorescent tubes utilizes with a specific space. This position of the mounting of the socket angle allowed the light output to be directed in a certain position without any loss of the beam candlepower provided by Fluorescent tubes due to the nature of the natural characteristics of the Fluorescent tube and utilizing the Fluorescent tube as a reflector.

As is apparent from the above description, the design of the invention, the supporting cuts formed in the photo provided permits the user to maximize the utilization and performance of the Fluorescent U shape tube by increasing the amount of the tube within a dedicated space, decreasing the housing fixture size by a considerable percentage. This invention allows for the fixture to be assembled with high efficiency, repair of the unit on location became simpler and requires lesser tools. The ability to control the light output by utilizing a lesser amount of Fluorescent tube can be provided without the need of new design fixture as the Fluorescent tubes are controlled in increment of 1 or 2 tubes independently or collectively. Thus providing a better lighting control accurately and without adjustment in addition to controlling the complete instrument via control board. Accordingly, the present invention is not intended to be limited to the particular embodiments illustrated but is intended to cover all such alternatives, modifications, and equivalents as may be included within the spirit and broad scope of the invention as defined by the following claims and their equivalents. In this context, equivalents means each and every implementation for carrying out the functions recited in the claims, even if not explicitly described herein Patent application and photos referred to herein are hereby incorporated by reference in their entity.

What is claimed:

1. A Fluorescent light comprising:
a base housing
a glass U shape tube connected to said base and surrounding with a variety of phosphor coatings permits a color corrected tubes for studio and film photography along a longitude axis through said base and said tube, said phosphor having a coating wound along the glass tube envelop.

2. The tube according to claim 1 wherein said peripheral portion wraps in a variety of phosphor coatings around said U shape tube.

3. The tube according to claim 2 wherein said peripheral portion wraps cylindrically around said U shape tube.

4. A variety of phosphor coatings for use in Fluorescent tube having a central axis, said phosphor coatings permits a variety of color characteristics adapted to be positioned coaxially on said U shape tube.

5. Increasing the amount of tubes in a lesser space of about 33.33% to 50% on the same housing in addition the utilization of the Fluorescent tube as a reflector material
